(19) United States
(12) Patent Application Publication
(10) Pub. No.: US 2013/0020543 A1
(43) Pub. Date: Jan. 24, 2013

(54) Wheel Weasel

(71) Applicant: Cass A. Ellsworth, Riverside, CA (US)

(72) Inventor: Cass A. Ellsworth, Riverside, CA (US)

(21) Appl. No.: 13/550,430

(22) Filed: Jul. 16, 2012

Related U.S. Application Data
(60) Provisional application No. 61/572,427, filed on Jul. 15, 2011.

(51) Int. Cl. B66F 3/00

(52) U.S. Cl. 254/131

(57) ABSTRACT

The invention provides an improved leveraging tool configured to safely lift a tire to a tire hub. Manufactured of an approximately one half inch powder coated and rust resistant steel rod, the Wheel Weasel features a triangle shaped framework, forming a base, two elongated and extended parallel arms extend from the corners of the base. The other two sides of the triangle culminate in a handle. The parallel arms are designed to slide beneath the tire. This base and arms cradle the tire and enables the user to lift it up off the ground. The two sides of the triangle extend downward and out from the handle at approximately a forty five degree angle.

### CLAIM OF PRIORITY

This patent application claims priority under 35 USC 119 (e) (1) from U.S. Provisional Patent Application Ser. No. 61/572,427 filed Jul. 15, 2011, of common inventorship herewith entitled, “Wheel Weasel.”

### FIELD OF THE INVENTION

The present invention pertains to the field of automotive supplies, and more specifically to the field of tire changing tools.

### BACKGROUND OF THE INVENTION

The prior art has put forth several designs for tire changing tools. Among these are:

US Patent 2004/0068852 to Enos Nolan describes a tire changing aid of thirty gauge mild steel that lifts and holds a spare tire in place while aligning lugs and lug holes. This invention has an extended arm and handle attached to two forked sides.

U.S. Pat. No. 5,562,389 to Frank Mitchell describes a tool for lifting and positioning a tire and wheel assembly in position for installation or removal from a vehicle hub. The tool comprises a pair of base members which form a cradle for receiving the tire and terminate In pivot members with beveled points that contact the ground. A handle means for lifting the tire may be folded for compact storage.

U.S. Pat. No. 5,180,141 to Thomas R. Hunt describes a tool for removing, maneuvering and replacing a wheel tire assembly on a wheel axle. The elongated tool comprises a wheel support section, a leverage section and a handle section.

None of these prior art references describe the present invention.

### SUMMARY OF THE INVENTION

It is an object of the present invention to provide an improved leveraging tool for use in changing a tire.

### BRIEF DESCRIPTION OF THE DRAWINGS

FIG. 1 shows two perspective prototypical views of the present invention.

FIG. 2 is a zoom functional view showing the present invention under a tire.

FIG. 3 is a functional view showing a sedan car with the present invention under its front right tire.

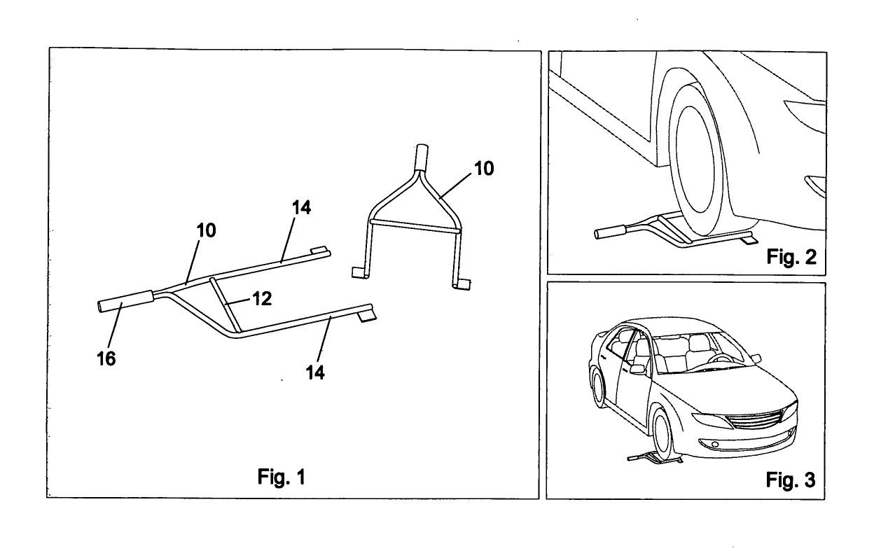

### DETAILED DESCRIPTION OF THE INVENTION

Millions of people rely on the automobile to transport them to their desired destination. Because of the mechanical nature of an automobile, however, malfunctions and problems are inevitable. A commonly experienced problem associated with cars is a flat tire. To change a flat tire, one uses a standard vehicle jack and lug wrench to raise the vehicle, removes the lug nuts from the tire, removes the flat tire and replaces it with a spare or a new tire. Changing a tire is a common part of the job for mechanics and car care specialists. Changing a tire is physically demanding. The bulk and weight of the tire and wheel assembly makes handling a tire awkward and taxing. For both car drivers and professional mechanics, changing a tire may result in chronic muscle pain and tension. Some people solve this problem by squatting or sitting directly on the ground when changing a tire, to eliminate the need to bend or stoop over. Physical limitations, along with wet and dirty ground conditions, deter many people from squatting or sitting on the ground.

The present invention, hereinafter referred to as the Wheel Weasel, is a leveraging tool configured to safely lift a tire to a tire hub. Manufactured of an approximately one half inch powder coated and rust resistant steel rod, the Wheel Weasel features a triangle shaped framework 10. A base 12, forms the bottom of the triangle, two elongated and extended parallel arms 14 extend from the corners of the base 12. These arms 14 are designed to slide beneath the tire. This base 12 and arms 14 cradle the tire and enables the user to lift it up off the ground. Positioned at the proximal end of the Wheel Weasel is an extended cylindrical handle 16. This handle is gently contoured with a nonskid coating to provide a comfortable and secure grip during use. The two sides 10 of the triangle, each approximately seven and one half inches in length, extend downward and out from this handle 16 at approximately a forty five degree angle. These arms 10 are joined together at the base of each arm by a horizontal support arm 12 measuring approximately fifteen inches. This configuration creates a triangle in the tool. At this juncture, the two arms 14 run parallel with one another and fork upwards at approximately a forty five degree angle. These two arms each measure approximately thirty three and one half inches in length from the base of the horizontal support bar to the distal end of the unit. The overall length of the Wheel Weasel measures approximately forty one inches.

Application and use of the Wheel Weasel is very simple and straight forward. Utilizing a tire jack to raise the vehicle several inches off the ground, the user removes the tire's lug nuts, slides the damaged tire on the Wheel Weasel, and safely and effortlessly removes the damaged tire. The user rolls the replacement tire and its attached wheel or rim to the front of the tire well, resting the tire against the well in the upright position. The user grasps the Wheel Weasel by its extended handle and rests the unit's two extended and elongated parallel arms flat on the ground, directly in front of the tire. Sliding the unit forward, the user then positions the extended arms beneath the tire until the tire rests entirely atop the Wheel Weasel. At this point the unit is angled upwards. The user simply lifts the handle, which raises the angled and extended arms and cradles the tire upwards toward the tire hub. With the center of the tire raised in front of the hub, the user slides the tire off the end of the Wheel Weasel on to the hub. The user mounts the lug nuts to the tire and mount, securing the tire in place. The Wheel Weasel stores away in a vehicle trunk or garage until needed again.

The Wheel Weasel provides consumers with a simple and expeditious means of changing a tire. An easily operated tool which securely holds a tire in the upright position while providing the leverage necessary to lift the tire several inches up off the ground toward the tire hub, the Wheel Weasel enables consumers to complete this arduous task in a quick and comfortable manner. The user operated the Wheel Weasel while standing upright, so they never have to stoop, squat or sit on the ground and lift a bulky tire. The Wheel Weasel also prevents a user body and clothing from being sullied by ground sludge, dirt and debris. For professional mechanics, tow truck operators and other automotive specialists, the Wheel Weasel could is an invaluable addition to their tool inventory, enabling them to change literally dozens of tires in the course of a day without the risk of injury and muscle strain. Simple to use, professionals and do-it-yourselfers alike appreciate the ease with which the Wheel Weasel is operated. Durably constructed of heavy duty stainless steel material, the Wheel Weasel withstands years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved leveraging tool for use in changing a tire, comprising: a triangle shaped framework wherein the bottom of the triangle forms a base, two elongated and extended parallel arms extending from the corners of the base, wherein these arms are designed to slide beneath a tire, further comprising an extended cylindrical handle positioned at the proximal end of the device where the two sides of the triangle come together, wherein the two sides of the triangle extend downward and out from this handle at approximately a forty five degree angle.

2. The leveraging tool of claim 1 manufactured of an approximately one half inch powder coated and rust resistant steel rod.

3. The leveraging tool of claim 1 wherein the cylindrical handle is gently contoured with a nonskid coating to provide a comfortable and secure grip during use.

4. The leveraging tool of claim 1 wherein the two sides of the triangle, are each approximately seven and one half inches in length.

5. The leveraging tool of claim 1 wherein the two sides of the triangle are joined together at the bottom of each arm by a horizontal support arm forming the base of the triangle which measures approximately fifteen inches in length.

6. The leveraging tool of claim 1 wherein these two parallel arms each measure approximately thirty three and one half inches in length.

7. The leveraging tool of claim 1 wherein the overall length of the tool is approximately forty-one inches in length.
